(19) United States
(12) Patent Application Publication
(10) Pub. No.: US 2014/0050910 A1
(43) Pub. Date: Feb. 20, 2014

(54) RAPID MACRO-SCALE SYNTHESIS OF FREE-STANDING GRAPHENE, HIGH PERFORMANCE, BINDER-FREE GRAPHENE ANODE MATERIAL, AND METHODS OF SYNTHESIZING THE ANODE MATERIAL

(71) Applicant: Rensselaer Polytechnic Institute, Troy, NY (US)

(72) Inventors: Rahul Mukherjee, Troy, NY (US); Abhay V. Thomas, Troy, NY (US); Nikhil Koratkar, Clifton Park, NY (US); Eklavya Singh, Troy, NY (US)

(73) Assignee: Rensselaer Polytechnic Institute, Troy, NY (US)

(21) Appl. No.: 13/966,395

(22) Filed: Aug. 14, 2013

Related U.S. Application Data
(60) Provisional application No. 61/683,380, filed on Aug. 15, 2012.
(60) Provisional application No. 61/781,374, filed on Mar. 14, 2013.

(51) Int. Cl. H01M 4/133; H01M 4/96; H01M 4/583; H01G 9/042; H01M 4/66; C25D 5/48

(52) U.S. Cl. CPC H01M 4/133; H01M 4/663; C25D 5/48; H01M 4/583; H01G 9/042; H01M 4/96
USPC 428/219; 549/512; 423/448; 205/224; 428/221

(57) ABSTRACT

A method of synthesizing a sheet of graphene oxide paper includes combining graphite oxide with water to form a colloidal suspension of graphene oxide; providing a working electrode and a counter electrode such that the working electrode and the counter electrode are inserted in the colloidal suspension; applying a potentiostatic field until a film of graphene oxide having a predetermined thickness forms on the working electrode; and drying the film to form a graphene oxide paper. The method may also include reducing the graphene oxide to graphene by either photo-thermal reduction or thermal exfoliation. The reduced graphene material exhibits high energy density as well as high power density making it useful as anode material for rechargeable batteries.

### CROSS-REFERENCE TO RELATED APPLICATIONS

This application claims the benefit of priority to U.S. Provisional Application Ser. No. 61/683,380, filed Aug. 15, 2012 and to U.S. Provisional Application No. 61/781,374 filed Mar. 14, 2013. The contents of all of these applications are incorporated in their entirety by reference herein.

### FIELD OF THE INVENTION

The invention relates to graphene and processes for manufacturing graphene anode material which may be incorporated into commercial applications, such as rechargeable batteries.

### BACKGROUND OF THE INVENTION

Graphene, a single layer of carbon atoms bonded in a hexagonal lattice, is a material having various advantageous physical properties, as well as being an excellent conductor of both heat and electricity. Such properties include high values for Young's modulus (˜1,100 GPa), fracture strength (125 GPa), thermal conductivity (˜5,000 W m⁻¹K⁻¹), mobility of charge carriers (200,000 cm² V⁻¹ s⁻¹), and specific surface area (2,630 m² g⁻¹). Graphene-based free-standing paper has recently attracted significant attention owing to its aforementioned superior properties. Free-standing paper-like materials have found commercial success in various technical applications, such as protective coatings, dielectric barriers, gas impermeable membranes, and electrode materials.

In order to realize a practical benefit from graphene in a commercial application, manufacturing methods must be developed which are able to provide the material in a form that is easily utilized as a raw material and which are economically feasible. Presently, methods employed to synthesize graphene oxide (GO) sheets include vacuum filtration of colloidal dispersions of GO in water to construct flexible paper-like structures. In this process, the solution may be filtered under vacuum through an Anodisc membrane, and the paper forms by the interlocking of the individual GO sheets. The resulting paper may then be dried and peeled off the Anodisc membrane. As the initial few layers of GO build up with time, the flow of water is gradually impeded and the time taken for the water to filter through the pores of the Anodisc membrane increases significantly. Vacuum filtration is thus a process that is both slow, taking up to 4 days to create a ˜5 μm thick paper, and non-scalable.

An example of a promising potential commercialization opportunity for graphene is in rechargeable batteries. Lithium ion batteries, for example, serve as primary energy storage systems for portable electronics like laptops and mobile phones. They have also been long regarded as a potential replacement for conventional combustion engines in automobiles, thereby paving the way for electric vehicles. Over the past decade, rising environmental concerns along with the cost of gasoline have further propelled research and development in electric vehicles (EVs) and hybrid electric vehicles (HEVs). In automotive application, it is common for lithium ion batteries to include graphite-based electrodes. However, the scope of graphite-based conventional lithium ion batteries is limited in successful large-scale commercial application in EVs and HEVs owing to their low power densities. As a result, lithium ion batteries used in automotive applications today are often coupled with an additional source of energy, such as conventional combustion engines or capacitors. Incorporation of additional energy storage systems not only complicate the design of the electric vehicle, but naturally add to the cost of the vehicle, making it less viable economically.

However, as mentioned above, it is very challenging to rapidly synthesize thick GO films with sufficient active mass for various device applications. For instance, the industrial standard for electrode mass density in lithium-ion battery technology has been set at a minimum of 5 mg/cm². GO paper fabricated by vacuum filtration achieves a mass density of less than 1 mg/cm². In order to have commercial feasibility, it is therefore imperative to be able to build GO papers that are at least 3-fold thicker in less time.

### SUMMARY OF THE INVENTION

There is therefore a need for methods of synthesizing scalable structures of graphene in the form of free-standing (flexible) papers. There is also a need for the development of improved electrode materials for lithium ion batteries that can provide high energy density as well as high power density to obviate the need for additional energy storage systems.

It is an aspect of the present invention to provide an improved method of synthesizing a sheet of graphene oxide paper. The method comprising:
a. combining graphite oxide with water to form a colloidal suspension of graphene oxide;
b. providing a working electrode and a counter electrode such that the working electrode and the counter electrode are inserted in the colloidal suspension;
c. applying a potentiostatic field until a film of graphene oxide having a predetermined thickness forms on the working electrode; and
d. drying the film to form a graphene oxide paper.

It is another aspect of the present invention to provide an anode material that can provide high energy density as well as high power density and a method of making the anode material. The method comprises at least one of photo-thermally reducing and thermally exfoliating a sheet of graphene oxide to form a graphene paper.

### BRIEF DESCRIPTION OF THE FIGURES

The invention is further described by reference to the following Figures in which:

FIG. 1a is a top view SEM image of reduced graphene obtained by photo-thermal reduction of graphene oxide using a flash according to one embodiment of the present invention;

FIG. 1b is a cross sectional SEM image of the reduced graphene obtained by photo-thermal reduction of graphene oxide using a laser according to another embodiment of the invention;

FIG. 1c is a top view SEM image of reduced graphene obtained by thermal exfoliation of graphene oxide according to another embodiment of the present invention;

FIG. 1d is a top view SEM image of chemically reduced graphene;

FIG. 2a is a plot of the change in current and resistance as a function of time during electroplating of free-standing graphene oxide solution according to yet another embodiment of the present invention;

FIG. 2b is a plot of the change in current in FIG. 2a and film thickness as a function of time;

FIG. 3a is a plot illustrating the change in discharge capacity for several discharge rates as a function of the number discharge cycles for a photo-thermally reduced RGO paper according to yet another embodiment of the present invention;

FIG. 3b is a plot of the charge storage capacity of the RGO paper in FIG. 3a;

FIG. 3c is a Ragone plot of the power and energy density obtainable from the RGO paper in FIG. 3a;

FIG. 4a is a cross-section SEM image of an electro-deposited graphene oxide paper with thickness in excess of 20 μm according to yet another embodiment of the present invention;

FIG. 4b is a plot of current over time of the electro-deposition performed to produce the graphene oxide paper of FIG. 4a;

FIG. 4c is a plot of thickness over time of the electro-deposition performed to produce the graphene oxide paper of FIG. 4a;

FIG. 4d is a cross-section SEM image of a photo-thermally reduced GO paper prepared from the graphene oxide paper of FIG. 4a;

FIG. 5 is an SEM image of a composite material of graphene oxide and silicon made according to yet another embodiment of the present invention;

FIG. 6a is a comparison of the rate capability and repeatability of photo-thermally reduced graphene made according to yet another embodiment of the present invention and other forms of graphene paper reduced by conventional methods;

FIG. 6b is a plot of the rate capability of thermally exfoliated graphene according to yet another embodiment of the present invention;

### DETAILED DESCRIPTION OF THE INVENTION

In an embodiment of the present invention, graphite oxide may be used as a starting material to produce graphene paper. Graphite oxide may be obtained from the oxidation of graphite by using conventional methods known to those of skill in the art. For example, Hummers method which involves the use of strong acids (e.g. sulfuric acid and nitric acid) and potassium chlorate. The graphite oxide powder may be extracted from the solution using a high speed centrifuge and washed with de-ionized water until the pH value becomes neutral followed by drying in a vacuum oven.

Analogous to graphite, graphite oxide also has a layered structure containing stacked GO sheets. GO is a highly oxidized state of graphene in which the sp² carbon bonded network is disrupted locally to form sp³ islands due to the attachment of oxygen functional groups such as epoxide, hydroxyl and carbonyl groups. When graphite oxide is sonicated in water, it readily exfoliates into a colloidal dispersion of individual GO sheets dispersed in water. This occurs because GO is strongly hydrophilic which enables water molecules to infiltrate into the layered graphite oxide and pry open the structure under ultrasonic agitation.

GO paper is electrically insulating due to the disruption of the sp² carbon bonding network of graphene by the oxygen functional groups. Consequently to restore the electrical conductivity, the paper must be reduced to produce reduced graphene oxide (RGO). Conventional methods employed to accomplish the reduction of GO paper include chemical reduction by exposing the paper to flowing hydrazine vapor or high temperature anneal of the GO paper in a hydrogen atmosphere. The use of chemical reduction is complicated, slow, and dangerous as it involves the use of toxic compounds. Furthermore, the resulting RGO paper has a relatively low surface area since the RGO sheets tend to re-stack and agglomerate due to attractive van der Waals interactions.

Methods according to the present invention may be used to manufacture GO paper-like structures in approximately two orders of magnitude less time than by vacuum filtration while allowing for thick (scalable) material deposition and may include processing steps for the instantaneous reduction of GO to RGO paper without the use of harmful chemicals.

According to an embodiment of the present invention, bulk quantities of graphite oxide may be synthesized from graphite using the Hummers method and then ultrasonicated in water to create a colloidal suspension of GO sheets in water. Next, two electrodes immersed in the GO suspension may be used to generate a potentiostatic field, preferably a constant dc voltage of approximately 10 V or higher. The working electrode is preferably an aluminum foil-cellulose ester membrane assembly, while a stainless steel mesh may preferably be used as the counter electrode. The presence of the cellulose ester membrane prevents electron transfer from the aluminum to the graphene oxide. Preventing electron transfer avoids in situ reduction of graphene oxide to graphene, which further limits the achievable thickness in the as-deposited film by preventing self-assembly observed in graphene oxide deposition. Furthermore, the membrane also allows the graphene oxide to be peeled off with relative ease following deposition. The mesh-type counter electrode prevents agglomeration of dispersed graphene oxide and thereby facilitates layer-by-layer deposition and self-assembly of graphene oxide on to the working electrode.

The processes according to the present invention are preferable to vacuum filtration because the dimensions of the GO paper structures are not limited by the size of the Anodisc membrane. Furthermore, the thickness of the deposited film may not be limited, as in standard electrophoretic deposition and can be accurately controlled by varying certain parameters, such as GO concentration, pH level of the solution, the dc voltage with and without superimposed ac component, and the physical separation between the electrodes. Electroplating or electrodeposition is also an almost ubiquitous process, highly scalable and compatible with processing tools used in large industries such as semiconductors, photo-voltaics, and metals and minerals processing.

According to embodiments of the present invention, as soon as the potential is raised above approximately 1.23 V, water electrolysis may be activated, and the GO particles may begin to migrate towards the electrodes along within the dispersion. After a period of time (based on the desired thickness of the film), the working electrode with the deposited GO is taken out and left to dry in ambient air at approximately 50° C. for 2 hours. At the end of the drying stage, a free-standing GO paper of desired thickness may be removed from the working electrode. The resulting GO paper made according to the present invention has very similar structure/properties to that obtained from vacuum filtration, in addition to a carbon to oxygen ratio of approximately 2.5:1, as revealed by X-ray Photoelectron Spectroscopy.

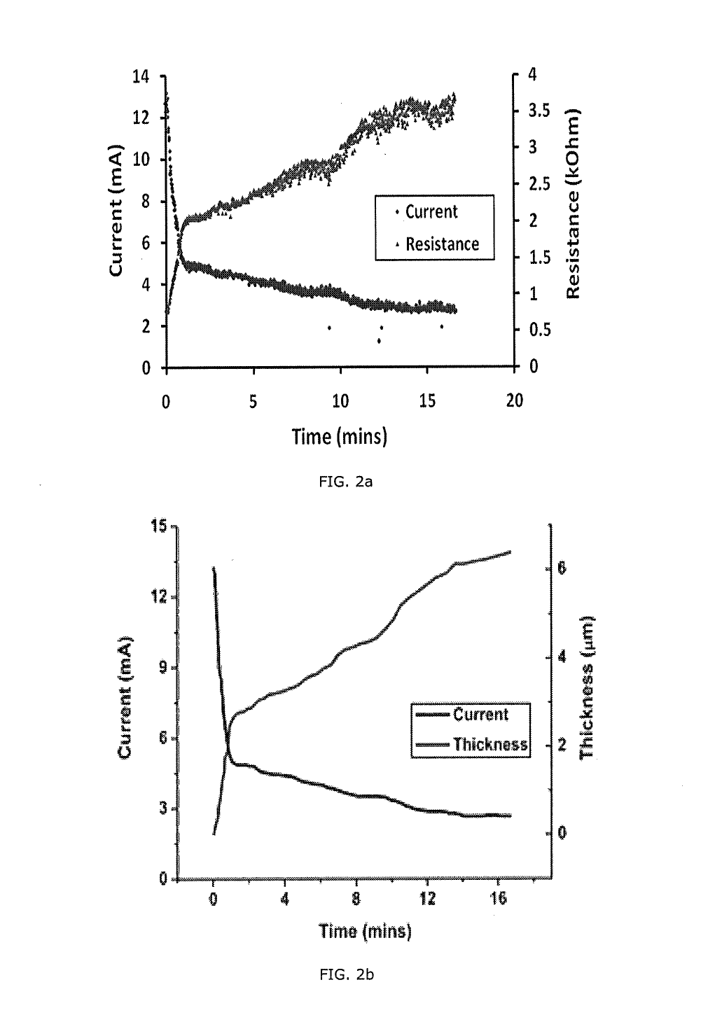

Processes according to present invention are highly repeatable, and enable the GO film thickness to be calculated in-situ because as the insulating graphene oxide film deposits on the working electrode, the current between the working and counter electrodes (associated with water electrolysis) diminishes (FIGS. 2a and 2b), i.e. resistance increases; therefore, the resistance is directly proportional to the film thickness.

According to another embodiment of the present invention, the GO paper may be further processed by using photo-thermal reduction or thermal exfoliation to reduce the GO paper to an RGO paper. Photo-thermal reduction may be preferably achieved by using a flash or a laser. The photo-thermally reduced sheets may be used in various applications, such as anode material in lithium ion batteries that are capable of achieving high energy density, as well as high power density. In yet another embodiment of the present invention, GO paper may be thermally exfoliated to produce a binder-free RGO paper.

A critical attribute in developing high performance lithium ion batteries is that the battery should demonstrate high repeatability and capacity retention. Lithium ion batteries are required to operate over many cycles with a continuously varying demand. It has often been observed that this varying demand contributes strongly to a deterioration in capacity retention and hence, poor repeatability. This in turn reduces the life of the lithium ion battery. RGO paper produced by using either photo-thermal reduction or thermal exfoliation according to the present invention may exhibit an excellent lifetime over thousands of charge/discharge cycles. This particular attribute is especially important while considering lithium ion batteries for applications in EVs and HEVs which are expected to perform for ten to fifteen years, unlike batteries used in portable electronic devices which have an average life of about two years. Anode material according to the present invention may retain almost 100% of the capacity even after extended cycling and may therefore be far superior to conventional graphitic electrode material. Thus, graphene based anodes according to the present invention may replace conventional graphitic electrodes in lithium ion batteries with the potential to be applicable in high performance driven applications, such as electric vehicles, as well as in portable electronic devices such as laptops and cell phones.

Lithium ion batteries provide capacities through intercalation between lithium ions and carbon and are thus strongly dependent on the diffusivity of lithium ions through the anode material and electron conductivity. A slow diffusion of lithium ions would prevent complete lithiation of the anode material and would thus provide very poor capacities. In addition, a high surface area is also desired in the electrode material, especially for high power applications since lithium ions should have access to sufficient active intercalation sites for efficient performance over quick charge/discharge cycles.

The reduction of GO paper to RGO paper according to the present invention is carried out by instantaneous and extensive heating of graphene oxide that induces a deoxygenation reaction that is extremely efficient, providing very high carbon to oxygen ratios. As explained above, the photo-thermal reduction may be achieved by using a high intensity xenon flash, such as a flash incorporated in a digital camera, or a laser scanning across a graphene oxide paper may be used to reduce the graphene oxide to graphene. Such photo-thermal reduction instantaneously heats the carbon material inducing a deoxygenation reaction which also removes C atoms from the graphene lattice because the oxygen escapes as CO₂. This rapid out-gassing generates a multitude of micro to nano-sized holes or cracks in the basal planes of graphene. The RGO papers made using either a flash or a laser for photo-thermal reduction exhibit similar structural morphology which comprises “open pores.” As used herein throughout the specification and the claims, “open pores” means pores, cracks, and intersheet voids that are visible from an SEM image. The RGO papers made according to either of the preferred photo-thermal reduction processes also exhibit similar electrochemical performance.

RGO paper prepared by thermally exfoliating a GO paper according to another embodiment of the invention comprises exposing a free standing graphene oxide paper to high temperatures, approximately 200° C.-900° C., in an inert atmosphere for short periods of time ranging from 10 seconds to 60 seconds to produce a structural morphology having open pores, similar to RGO paper produced by photo-thermal reduction.

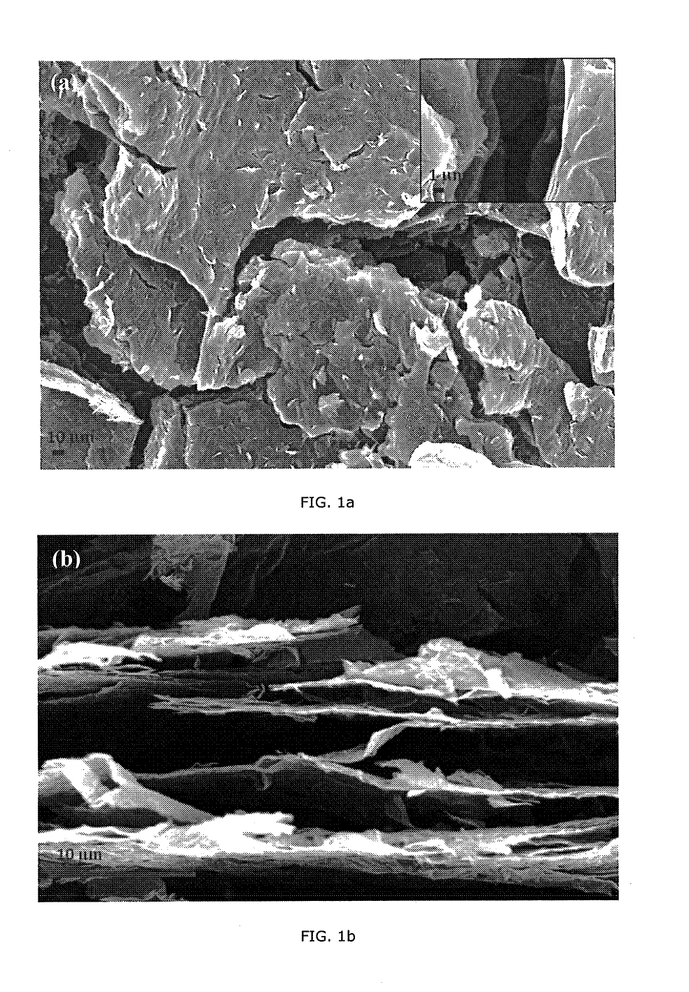

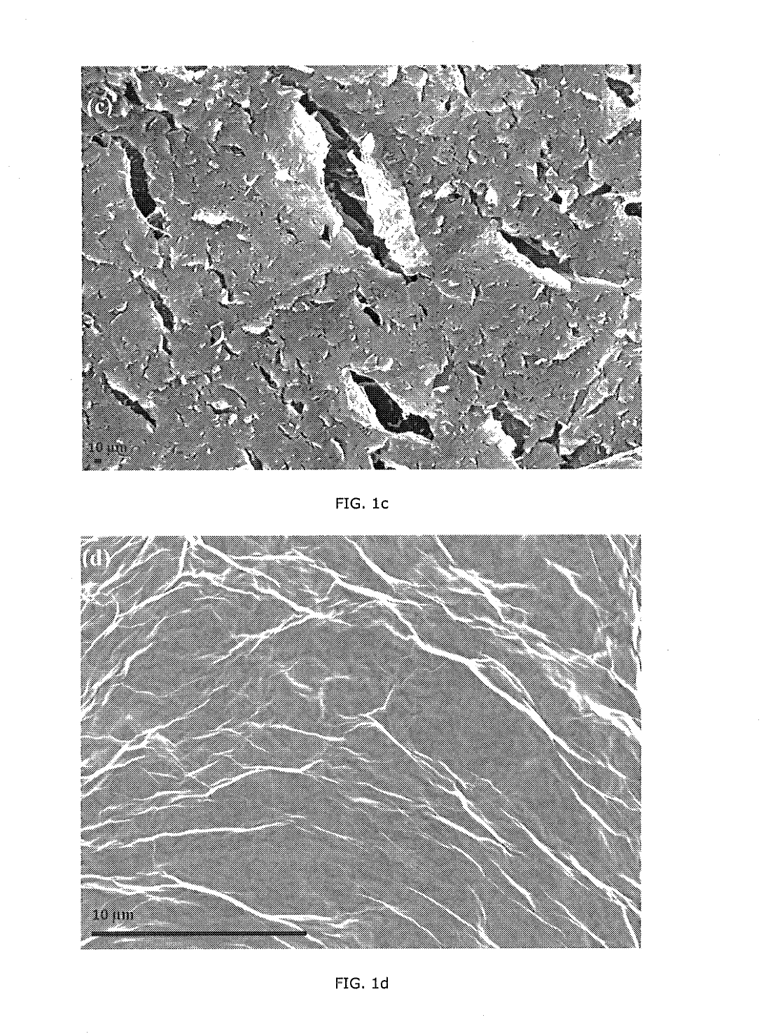

FIGS. 1a and 1b are scanning electron microscopy (SEM) images of GO papers that have been photo-thermally reduced. In each of the images, deep cracks are observed in the RGO paper that expose the underlying sheets of graphene. Conventionally prepared free-standing graphene paper via hydrazine reduction shows a distinct absence of such an open pore structure (FIG. 1d).

The open pore structure of various embodiments of the present invention exposes the underlying graphene sheets enabling high rate capabilities and hence, high power densities in lithium ion batteries because the electrolyte has better access to the anode material, thereby facilitating efficient lithium ion transport and intercalation mechanism. FIG. 1b is a cross sectional SEM image of an RGO paper that was photo-thermally reduced by laser and demonstrates that photo-thermal reduction produces a rapidly expanded structure. The thickness of the RGO paper after photo-thermal reduction may be five to ten times thicker than the thickness of the original GO paper. This expanded structure further assists high rate capabilities, where discharge and charge occurs in as little as a few minutes, by providing ample active sites for lithium ion intercalation not only through the surface of the anode, but also along the cross section. Such a structure allows the direct diffusion of Li⁺ through the basal planes in graphene enabling ultra-fast Li⁺ intercalation kinetics as compared to graphitic anodes. The photo-thermal heating also welds the graphene sheets and creates cross-links between individual sheets in the structure. This facilitates efficient electron transfer within the electrode, lowering the charge transfer resistance nearly three-fold compared to graphite slurries, which is important for high power performance. The expanded cross-section increases the sheet-to-sheet spacing in RGO. A greater amount of Li ions can be intercalated into the expanded, open-pore structure of the RGO anode and adsorbed to the defects/edges of the graphene sheets, thereby increasing the energy density by ˜2.5-fold over traditional graphitic anodes.

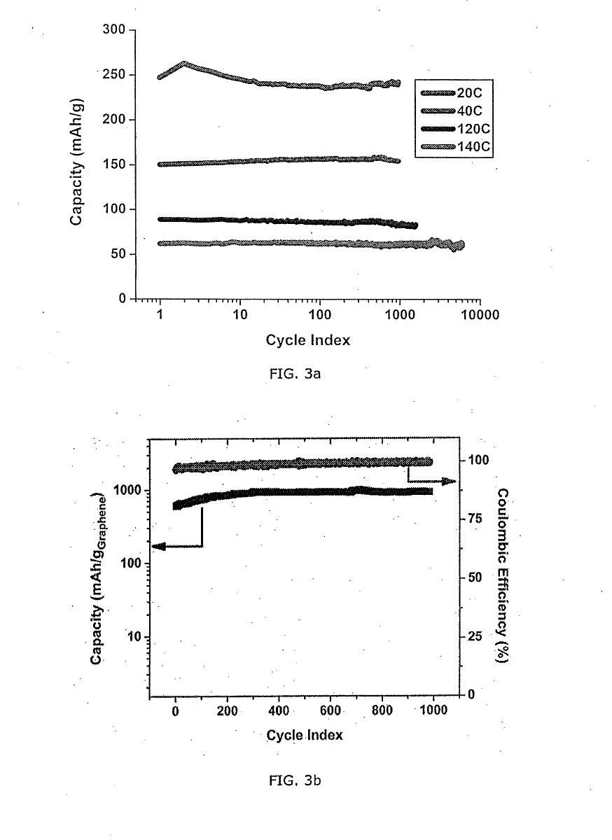

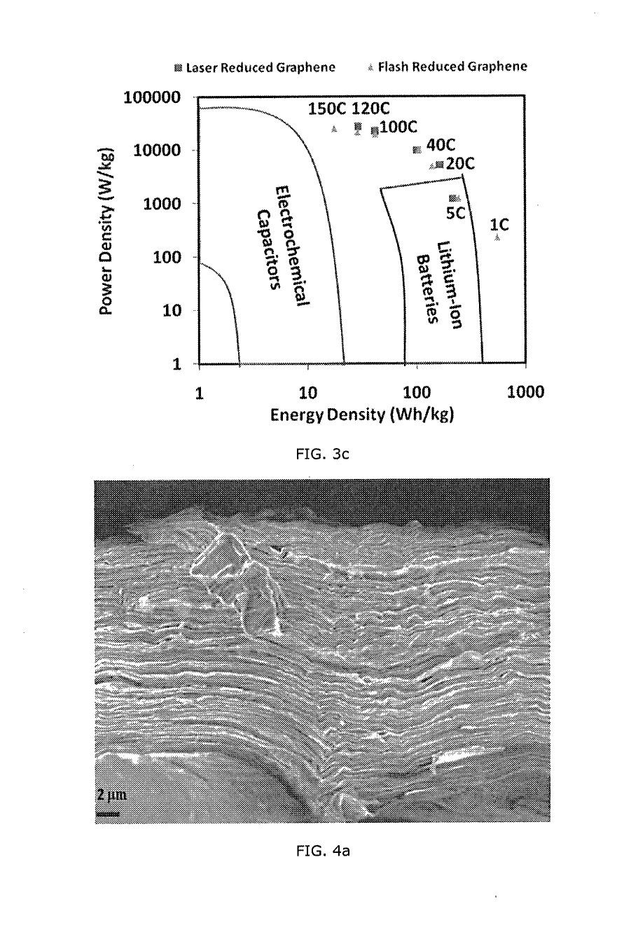

FIG. 1c is a top view SEM image of thermally exfoliated RGO paper. The surface structure is similar to the open pore and expanded structure of RGO paper obtained from photo-thermal reduction, except that the pore distribution is suppressed. Although thermally exfoliated RGO paper will have a less efficient high rate performance compared to photo-thermally reduced RGO paper, the limited distribution of pores may provide more structural stability of the material while still exhibiting excellent electrolyte wettability and superior performance at moderately high C-rates of up to 1 C. As used herein throughout the specification and in the claims, “C-rate” is defined as the time needed for a battery to charge or discharge, wherein the time is equal to 1/n hours for nC. For example, a C-rate of 1 C would be 1 hour. At a rate of 1 C, thermally exfoliated RGO paper may provide excellent energy densities, previously achievable only by non-carbon based materials such as tin, silicon and germanium, but over a much longer cycle life. Most importantly, the RGO paper according to the present invention may last for over 6,000 cycles of charge and discharge and without significant degradation in performance (FIG. 3a). At low charge/discharge rates, RGO may provide charge storage capacities as high as ˜900 mAh/g (corresponding to ˜2.5 lithium ions absorbed for every 6 carbon atoms) compared to ˜372 mAh/g which is the theoretical maximum for graphite (FIG. 3b). At high charge/discharge rates (>10 C) graphite anodes fail to provide any appreciable capacity, while RGO may provide capacities of ˜150 mAh/g at 40 C and ˜100 mAh/g at 100 C. The Ragone plot in FIG. 3c demonstrates the superiority of RGO over the conventional graphitic anodes that are ubiquitous in present Li-ion batteries.

According to embodiments of the present invention, photo-thermal reduction may result in superior deoxygenation of RGO paper, preferably an RGO paper having a carbon-oxygen ratio between 10.1:1 and 15.6:1, as well as a high surface area of approximately 200-400 m²/g and a large average pore diameter between about 65 and 90 nm. Conventional graphene paper reduced chemically via hydrazine reduction typically has a much smaller average pore size of 3.2 nm. A high carbon-oxygen ratio improves the performance of the lithium ion battery because the presence of oxygen containing functional groups has shown to contribute to irreversible capacities. According to another embodiment of the invention, thermal exfoliation may also result in deoxygenation of RGO paper, preferably a carbon-oxygen ratio of approximately 5:1, and a surface area of approximately 150-200 m²/g.

RGO paper made according to the present invention may be used in various applications, such as protective coatings, dielectric barriers, gas impermeable membranes to electrode materials in batteries, capacitors, and fuel cells. In Li-ion batteries in particular, RGO paper made according to the present invention may provide a promising alternative to graphite based slurries in the next generation of Li-ion batteries. Since RGO paper is self-supporting, it does not require any mechanical binders and serves as both the active anode material and the current collector simultaneously, thereby eliminating the use of Cu current collectors, substantially reducing the mass of the battery. Other potential commercial applications for RGO paper made according to the present invention are super-capacitors, hydrogen storage, chemical sensors, and photochemical energy production.

For super-capacitors, surface area is of particular relevance. Super-capacitors function primarily by means of surface reactions and hence, a porous graphene structure with high specific surface area would facilitate higher gravimetric energy densities, which represents the total charge stored per unit mass of the electrode. The intrinsic high electrical conductivity of graphene would also allow for quick charge transfer necessary to achieve high power densities. Further, the process for fabrication of the electrode may be extended to introduce a flexible substrate for electro-deposition and subsequent laser-reduction, resulting in a flexible super-capacitor device having stable performance even after 1,000 bending cycles. Moreover, thicker electrodes also provide sufficient mechanical robustness that would help realize next-generation flexible electronic devices.

Because of their exceptional energy densities (39 kWh/kg), hydrogen fuel cells have long been viewed as a viable alternative to conventional combustion engines. However, one of the primary constraints in hydrogen fuel cell devices has been the difficulties associated with inefficient and irreversible storage/release of hydrogen. RGO papers made according to the present invention offer an economic and scalable approach towards development of graphene-based hydrogen storage devices. RGO paper is mechanically robust and chemically stable and can thus be used for long-distance transportation without fear of material degradation. Finally, because embodiments of the present invention have high surface area, the RGO paper offers good control over porosity and can be efficiently functionalized to facilitate chemisorption of hydrogen molecules. Hydrogen molecules have a greater affinity towards corrugated edges of graphene sheets while reversing the curvature of the sheets results in a spontaneous release of hydrogen. Therefore, by simply stretching and compressing flexible and robust RGO paper, one can achieve efficient hydrogen adsorption and desorption. Hydrogen storage in graphene can also be achieved through chemisorptions which are realized by pre-treating graphene with alkali atoms such as lithium, sodium and potassium. For instance, for every single lithium atom attached to graphene, four hydrogen molecules can be adsorbed, resulting in a gravimetric density as high as 10 weight %. RGO paper made according to an embodiment of the present invention by photo-thermal reduction has the ability to accommodate ˜3-4 fold larger number density of lithium atoms, as compared to conventional chemically reduced graphene. The presence of more lithium for a given mass of graphene would directly translate to a greater adsorption of hydrogen molecules and hence enable higher hydrogen storage capacity.

Chemical sensors based on individual nanostructures are exquisitely sensitive to the environment but are costly, fragile and show poor repeatability (i.e. large variation from sample-to-sample). By contrast, macro-scale sensing devices such as conducting polymers of semi-conducting films offer improved reliability and ruggedness but suffer from low sensitivity. However, sensors made from RGO paper according to the present invention would potentially combine the high sensitivity of individual nano-sensors with the cost-effectiveness, reliability and practicality of conventional solid-state chemical sensor devices. The high conductivity of RGO and the presence of chemically active defect sites (as a result of the reduction step), enhances the sensitivity of the RGO device while reducing the low-frequency noise by 1-2 orders of magnitude as compared to conventional sensors. The sensitivity of chemically reduced graphene oxide to NO₂, NH₃, and acetone vapors has been measured to be in the parts per billion (ppb) range and involved low power electronics to operate.

Graphene, due to its high surface area, exceptional electron mobility and charge transfer characteristics has been used as an additive with photo-catalytic semiconductor materials in applications ranging from traditional solar cells to photo-catalytic hydrogen generation, hydrocarbon fuels from carbon dioxide and even aromatic pollutant degradation. Graphene allows electron transport at 1/300^{th} the speed of light thus allowing the photo-generated electrons from the semiconductor to have large diffusion distances. In its role as an electron sink, the graphene reduces recombination sites while simultaneously acting as a source for electrons at reaction sites. It also efficiently absorbs the entire spectrum of light by virtue of being black in color. The improvement in photo-catalytic activity through incorporation of graphene has been attributed to the efficient photo-generated electron transport through the graphene substrate to TiO₂ composites without undergoing an electron-hole recombination. Further, graphene can generate multiple electron-hole pair from a single absorbed photon which improves catalytic efficiency. Various embodiments of the present invention may include processes for preparing uniformly dispersed, freestanding and scaled-up graphene-catalyst composite materials for commercial photovoltaics, photocatalytic hydrogen production, CO₂ to hydrocarbon conversion and even other pollutant degradation units.

Macro-scale synthesis of graphene oxide and RGO paper according to embodiments of the present invention may enable commercialization of a vast range of graphene-based technology that have so far been limited by scalability issues that are generally associated with nano-scale building blocks. Moreover, rapid fabrication and possibility of co-deposition of composite materials through electro-deposition may provide greater flexibility and commercialization opportunities. The processes according the present invention may be highly repeatable, efficiently controlled, and the chemistry may be effectively modified to tailor to a variety of applications.

### EXAMPLES

In order that the invention may be more fully understood, the following Examples are provided by way of illustration only.

### Example 1

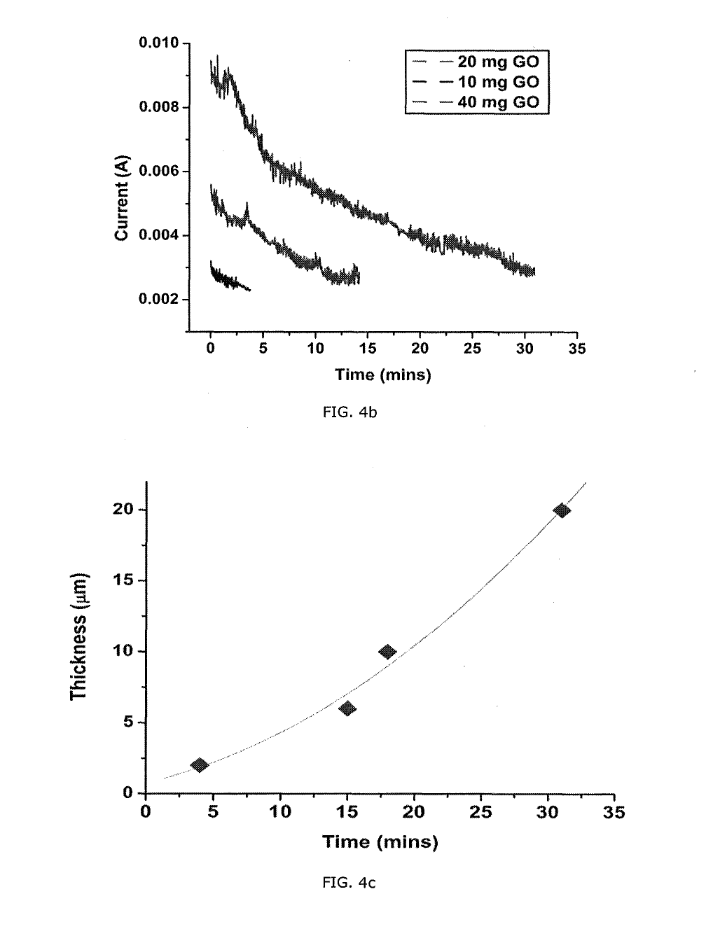

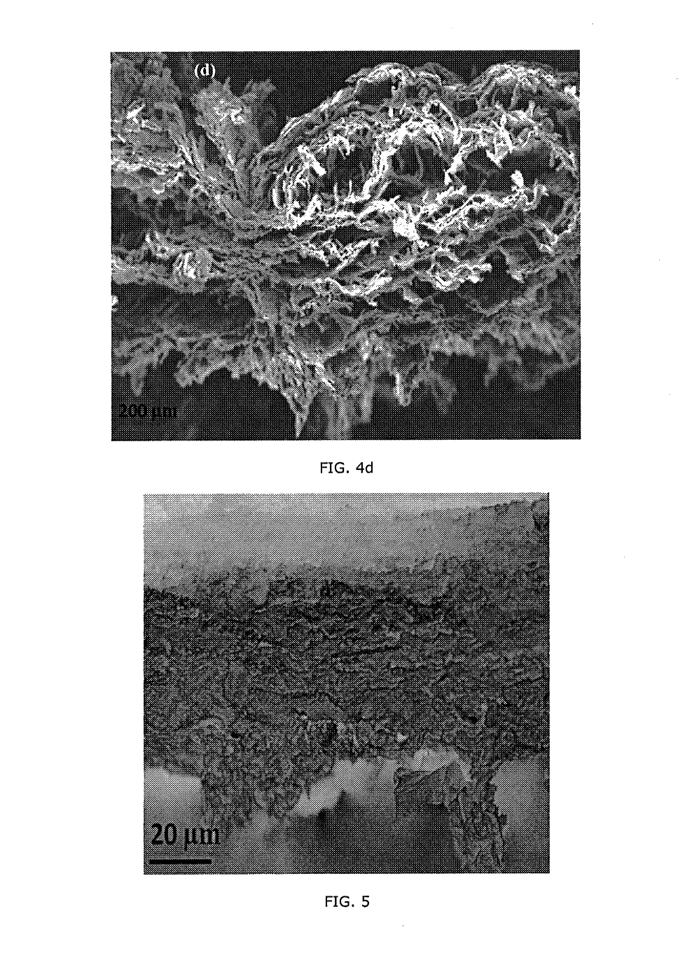

The relation between time-to-deposit and thickness of the deposited graphene oxide film was studied by conducting electro-deposition of different concentrations of graphene oxide solutions, (a) 10 mg GO, (b) 20 mg GO and (c) 40 mg GO, dispersed in 40 mL of deionized water. A potentiostatic field was applied, as described above. The current profile was observed and the deposition was stopped once the change in current with respect to time dropped below 50 μA/second (i.e. dI/dt<50 μA/second). Thicknesses of the GO papers obtained were 2 μm, 10 μm and 20 μm for 10 mg, 20 mg and 40 mg GO respectively and were determined through cross-sectional Scanning Electron Microscopy (SEM) imaging. SEM image of 20 μm thick paper, current vs time, and thickness vs time profiles have been provided in FIG. 4a-c and as can be observed from the profile, the thickness of the as-deposited GO paper linearly co-relates with time. A GO paper thickness of ˜20 μm was obtained using a deposition time that was ˜2 orders of magnitude less than the time needed to produce a GO paper by vacuum filtration having only one-quarter of the thickness. The ˜20 μm thick GO paper was reduced using a xenon flash from an Einstein™ E640 Studio Flash (manufactured by Paul C. Buff, Inc. of Nashville, Tenn.) set at an energy rating of 320 Ws and a power rating of 9 W. The resulting reduced graphene oxide paper was a highly porous yet extremely robust network of graphene sheets with a thickness greater than 0.5 mm (FIG. 4d). The flexibility of the process also facilitated significantly thicker GO papers to be fabricated in orders of magnitude lesser time as compared to traditional vacuum filtration techniques. It is to be noted here that the process flexibility also allows for fabrication of significantly thinner papers (˜10 nm) by simply varying the deposition parameters and the simultaneous deposition of composite materials as demonstrated through the successful co-deposition of graphene oxide and silicon (FIG. 5).

### Example 2

Photo-thermally reduced graphene and thermally exfoliated graphene were tested in Lithium-ion batteries. Photo-thermally reduced graphene and thermally exfoliated graphene samples were separately assembled in a 2032 coin cell against a lithium foil counter electrode and cycled between 0.03 V and 3 V at various C-rates. At 1 C, photo-thermally reduced graphene delivered a stable discharge capacity of ˜700 mAh/g, ˜1.5 times higher than that of conventional graphitic anodes while thermally exfoliated graphene delivered an impressive ˜900 mAh/g. Further, by varying the reduction parameters (energy intensity or power of the flash), the porous structure in RGO may be more effectively controlled to provide even higher capacities of up to 1000 mAh/g. A higher intensity reduction increases the inter-sheet gap within graphene and results in the formation of wider pores that help accommodate a higher concentration of lithium atoms during charge/discharge cycles, hence translating to higher capacities.

The performance of these graphene anodes at higher charge/discharge rates is particularly noteworthy. Lithium-ion batteries generally operate at rates of <1 C (1 C=charge/discharge time of 60 minutes). 5 C (charge/discharge time of ˜12 minutes) is considered a high-rate operating condition for such batteries. The short discharge times at 5 C did not however impede the intercalation process as the cells still measured discharge capacities as high as ˜370-335 mAh/g and ˜300 mAh/g for photo-thermally reduced graphene and thermally exfoliated graphene, respectively. Moreover, the capacities were stable over extended periods of cycling and were found to be highly repeatable. Such stable, long term high capacity performance is generally seen at much lower rates<1 C, as a result of which the power densities are significantly lower. At 5 C the cells delivered power densities of ˜1.2 kW/kg_{anode} and energy densities of ˜215-244.5 Wh/kg_{anode} and ˜200 Wh/kg_{anode} for laser reduced, flash reduced, and thermally exfoliated graphene respectively.

Even at a further accelerated charge/discharge rate of 40 C (charge/discharge in 1.5 minutes), photo-thermally reduced graphene delivered capacities as high as 156 mAh/g and power densities close to 10 kW/kg, more than two orders of magnitude higher than conventional graphitic anodes.

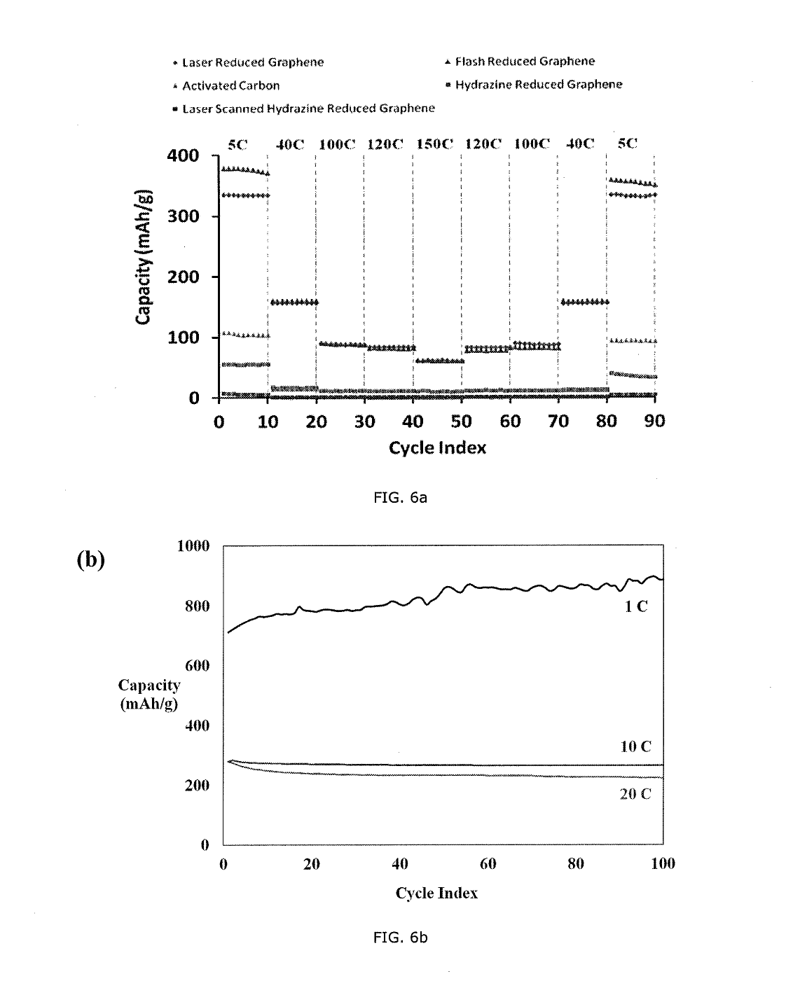

The cells containing photo-thermally reduced and thermally exfoliated graphene also displayed excellent repeatability. The lithium ion batteries were subjected to varying energy and power density demands. The photo-thermally reduced graphene displayed excellent structural and electrochemical stability as they could be efficiently cycled at various charge/discharge rates while maintaining nearly 100% capacity retention, as shown in FIG. 6a. In addition to flash and laser reduced graphene, FIG. 6a also includes data from additional control cells incorporating (a) activated carbon, a commercially accepted standard electrode material in lithium ion batteries prepared through use of binders and conductive additives, (b) hydrazine reduced graphene, the conventional approach to fabricate free-standing graphene paper, and (c) hydrazine reduced graphene after laser scanning the electrode material.

Control cells (a) and (b) were used as controls to demonstrate the role of the pore structure and the significant improvement that can be achieved through elimination of binders, and control cell (c) was used to confirm that the pore structure facilitates high rate capability is indeed contributed by deoxygenation reaction upon laser treatment. It is to be noted that when hydrazine reduced graphene was subjected to laser scanning open pore structures were not observed. At lower rates, thermally exfoliated graphene performed significantly better than the control samples providing excellent reversible capacities, stable over hundreds of cycles as shown in FIG. 6b.

Finally, to assess the long term cycle ability of photo-thermally reduced graphene anodes, the samples were tested at elevated charge/discharge rates of 20 C, 40 C, 120 C and 150 C for over 1000 charge/discharge cycles (FIG. 3a). The cells demonstrated excellent capacity retention throughout the entire cycle life, indicating superior structural integrity. The performance of the photo-thermally reduced graphene anodes in lithium ion batteries are represented in terms of energy and power densities through the Ragone plot in FIG. 3c. The performance of activated carbon, especially at high current densities, has also been plotted to provide a clearer comparison. At high current densities, a conventional activated carbon electrode rapidly loses energy density and behaves similarly to a conventional capacitor. On the other hand, flash and laser reduced graphene extends beyond the lithium ion batteries region, without displaying a significant loss in energy density. The binder-free thermally exfoliated graphene also behaved similarly providing excellent energy densities. The cycle ability and repeatability of these anodes further suggest that these anodes are capable of switching back and forth between high power and high energy density applications as and when required. This in turn implies that photo-thermally reduced graphene has the potential to be used over a wide range of operating conditions for various applications and especially for electric vehicles, which have high power demands during certain stages such as start-up and acceleration.

### Example 3

Electrochemical Impedance Spectroscopy (EIS) was carried out to study the electrochemical activity of photo-thermally reduced graphene anodes and thermally exfoliated graphene anodes. For comparison, EIS was also measured for chemically reduced graphene serving as a control cell. In the case of photo-thermally reduced graphene anodes, EIS was carried out after 1000 charge/discharge cycles when cycled at a rate of 40 C. For thermally exfoliated graphene, EIS was carried out after 500 charge/discharge cycles when cycled at a rates of 10 C and 20 C each. The high rate and long cycle life before EIS measurements were performed had been selected to take into account the effects of ageing, structural degradation and electrochemical evolution of the material. The impedance curve obtained was fitted with a modified Randles equivalent circuit and the contributions of charge transfer mechanism and interphase layer was calculated in terms of resistance. A higher interfacial resistance is generally indicative of a thick Solid Electrolyte Interphase (SEI) layer while a high charge transfer resistance suggests poor inter-connectivity within the electrode material. A thick SEI layer would prevent high rate capabilities since the lithium ions will then have to travel through the entire thickness of the inactive SEI layer before the on-set of intercalation reactions. In high rate applications where charge/discharge times are a few seconds to a few minutes, this prevents efficient capacity delivery. On the other hand, a high charge transfer resistance will prevent efficient electron transport kinetics, once again leading to poor capacities, especially evident at high charge/discharge rates.

The charge transfer resistance of laser reduced, flash reduced graphene and thermally exfoliated graphene was 48.1Ω, 73.2Ω, and 86Ω, respectively, while the charge transfer resistance of chemically reduced graphene was much higher at 130.4Ω. Charge transfer resistance is inversely related to the exchange current density and thus photo-thermally reduced graphene and thermally exfoliated graphene clearly demonstrated significantly higher electrochemical activity than chemically reduced graphene. Furthermore, despite having an expanded structure, individual graphene sheets still appeared to be networked strongly, which improves the charge transfer mechanism. The interfacial resistance of chemically reduced graphene was much higher at 95.1Ω, compared to 14.2Ω, 14.1Ω, and 28Ω for flash reduced, laser reduced, and thermally exfoliated graphene, respectively. Such high interfacial resistance significantly limits efficient diffusion and initiation of intercalation of lithium ions as mentioned above, especially at high C-rates. Moreover, since absence of an open pore structure in hydrazine reduced graphene demands that the lithium ion diffusion should be through the surface of the anode, a thick SEI can significantly limit the rate capabilities. In laser and flash reduced graphene samples, interfacial resistances were significantly lower, facilitating quick diffusion through the surface while the pores continued to provide an additional electrolytic pathway for the ions to intercalate with the underlying sheets. Low charge transfer and interfacial resistances along with the presence of wide pores and cracks thus ensured high rate capabilities and excellent repeatabilities of photo-thermally reduced graphene and thermally exfoliated graphene.

Apart from the long-term goal of incorporation of high performance lithium ion batteries in automotive applications, a near term and easily realizable goal would be introduction of such high performance electrode materials in lithium ion batteries used to power portable electronic devices such as laptops, tablet PCs and cell phones. Both photo-reduced and thermally reduced graphene are capable of delivering exceptional power densities which translates to quick charge in a matter of minutes (unlike laptops and cell phones at present which may take up to 2 hours or more to achieve full charge from a state of zero charge). Moreover, the high energy density implies that such portable devices would also be able to last longer on a single charge as compared to conventional graphitic electrodes that are used in commercial lithium ion batteries.

Photo-thermally reduced graphene and thermally exfoliated graphene according to embodiments of the present invention offers superior performance characteristics far surpassing conventional graphitic anodes that are presently in use in lithium ion batteries. Anode material according to the present invention which includes photo-thermally reduced graphene can provide excellent capacities even at elevated charge/discharge rates, ensuring high energy and power densities and are further capable of operating over thousands of cycles with excellent capacity retention and high repeatability. By eliminating the need for polymeric binders or conductive additives, the material cost can be reduced. Being free standing electrodes, they do not require aluminum or copper based current collectors, bringing the cost of materials further down. Since the present generation of lithium ion batteries also use carbon based electrode materials, introduction of photo-thermally reduced graphene and thermally exfoliated graphene would not require any significant change in technology or expertise. Moreover, both photo-thermal reduction and thermal exfoliation processes have the capability to be easily automated and does not involve high investments in infrastructure owing to the transition. In fact, these methods offer a cleaner, safer and more controlled approach towards fabrication of the electrode material when compared to the current standards.

While preferred embodiments of the invention have been shown and described herein, it will be understood that such embodiments are provided by way of example only. Numerous variations, changes, and substitutions will occur to those skilled in the art without departing from the spirit of the invention. Accordingly, it is intended that the appended claims cover all such variations as fall within the spirit and scope of the invention.

What is claimed:

1. A method of synthesizing anode material comprising:
combining graphite oxide with water to form a colloidal suspension of graphene oxide;
providing a working electrode and a counter electrode such that the working electrode and the counter electrode are inserted in the colloidal suspension;
applying a potentiostatic field until a film of graphene oxide having a predetermined thickness forms on the working electrode; and
drying the film to form a graphene oxide paper.

2. The method of claim 1, wherein the working electrode comprises an aluminum foil-cellulose ester assembly.

3. The method of claim 1, wherein the counter electrode comprises a stainless steel mesh.

4. The method of claim 1 further comprising at least one of photo-thermally reducing and thermally exfoliating the graphene oxide paper to form a graphene paper.

5. A graphene oxide paper made according to the method of claim 1.

6. A method of synthesizing graphene paper comprising at least one of photo-thermally reducing and thermally exfoliating a sheet of graphene oxide.

7. The method of claim 6, wherein photo-thermally reducing comprises heating the sheet of graphene oxide with a laser or flash.

8. The method of claim 6, wherein thermally exfoliating comprises exposing the sheet of graphene oxide to temperatures of approximately 200° C.-900° C. in an inert atmosphere for a time period of 10 seconds to 60 seconds.

9. The method of claim 6, wherein the sheet prior to the at least one of photo-thermal reduction or thermal exfoliation has an original thickness and following photo-thermal reduction or thermal exfoliation, the graphene paper has a final thickness, and a ratio of the original thickness to the final thickness is 1:10 to 2:10.

10. The method of claim 6, wherein following photo-thermal reduction or thermal exfoliation, the graphene paper has an oxygen content less than or equal to 10%.

11. A graphene paper having a stable discharge capacity of at least 300 mAh/g at a C rate of 5 C.

12. The graphene paper of claim 11 further comprising a surface that includes a plurality of open pores, the plurality having an average pore diameter of 65 to 90 nm.

13. The graphene paper of claim 11, wherein the stable discharge capacity is greater than or equal to 150 mAh/g when the C rate is 40 C.

14. The graphene paper of claim 11, wherein the stable discharge capacity is less than 150 mAh/g when the C rate is 40 C.

15. The graphene paper of claim 11 having a capacity retention greater than or equal to 98% after at least 1000 cycles of continuous charge/discharge at low (≦1 C) as well as high (≧1 C) rates of operation.

16. The graphene paper of claim 11 having a surface area of 200 to 400 m²/g.

17. The graphene paper of claim 11 having a charge transfer resistance less than or equal to 90Ω.

18. The graphene paper of claim 11 having an interfacial resistance less than or equal to 30Ω.

19. The graphene paper of claim 11, wherein the graphene paper is free of polymeric binder.

20. A rechargeable battery comprising the graphene paper of claim 11.
